(19) United States
(12) Patent Application Publication
(10) Pub. No.: US 2024/0200674 A1
(43) Pub. Date: Jun. 20, 2024

(54) CHECK VALVE

(71) Applicant: AKWEL, Champfromier (FR)

(72) Inventor: Christophe Bondran, Saint-Jean-De-Galaure (FR)

(73) Assignee: AKWEL, Champfromier (FR)

(21) Appl. No.: 18/526,008

(22) Filed: Dec. 1, 2023

(30) Foreign Application Priority Data
Dec. 8, 2022 (FR) 2212949

(51) Int. Cl. F16K 15/02; F16K 27/02

(52) U.S. Cl. CPC F16K 15/021; F16K 27/0209

(57) ABSTRACT

This check valve includes a casing delimiting an internal volume provided with an inlet, an outlet, a membrane, extending at least partially inside the internal volume of the casing, the membrane having a contact portion radially elastically deformable between a sealing position wherein the contact portion contacts an internal wall of the internal volume and a fluid opening position wherein the fluid can flow from the inlet to the outlet around the membrane. The membrane axially having a decreasing cross section, the casing includes on the inlet side an internal seat for receiving the distal portion and on the outlet side, an axial extension pin configured to extend inside the proximal portion of the membrane wherein the membrane is immobilized axially between the seat and the pin.

### TECHNICAL FIELD

The present invention relates to a check valve for a fluid circuit of a motor vehicle. It applies more particularly but not exclusively to a spraying device for distributing washing liquid onto a glass surface of a motor vehicle comprising such a valve.

In a manner known per se, a spraying device is used to distribute washing liquid onto a glass surface, such as for example the windshield or the rear window of a motor vehicle or else a glass surface of a headlight, a radar or camera of the motor vehicle.

In general, such a spraying device comprises a check valve which is generally in the form of a casing comprising an inlet and an outlet and an internal housing extending between the inlet and the outlet inside which extends at least partially a membrane element. The membrane element is configured to allow flow of liquid from the inlet to the outlet, but substantially prevents the flow of liquid back from the outlet to the inlet.

In operation, the valve prevents the total backflow of the washing liquid towards the inlet, which allows to maintain a certain amount of residual washing liquid at the outlet, for example at a spray nozzle, available for a next use of the spraying device. When a user of the device activates the spraying device, the residual washing liquid at the outlet allows faster initiation of the spraying and therefore a shorter response time.

### PRIOR ART

A device for spraying a washing liquid onto a window of a motor vehicle comprising a valve unit is already known from the prior art, in particular from patent FR 3 056 179 B1.

This valve unit comprises an elastomeric membrane element and a compression coil spring which biases the membrane element with a force opposite to that generated by the pressure of the washing liquid. The device described in this patent is relatively complex.

The invention aims in particular at providing a simplified check valve with a limited number of parts in order to reduce costs and improve the robustness of the valve.

### SUMMARY OF THE INVENTION

For this purpose, the object of the invention is a check valve for a fluid circuit of a motor vehicle, comprising a casing delimiting an internal volume provided with an inlet, an outlet and defining a main axis X of flow of fluid between the inlet and outlet through the casing, a membrane element, extending at least partially inside the internal volume of the casing, the membrane element having a contact portion radially elastically deformable between a sealing position wherein the contact portion contacts an internal wall of the internal volume and a fluid opening position wherein the fluid can flow from the inlet to the outlet around the membrane element, characterized in that the membrane element axially having a decreasing cross section between a proximal end portion forming the contact portion and an opposite distal end portion, the casing comprises on the inlet side an internal seat for receiving the distal portion and on the outlet side an axial extension pin configured to extend inside the proximal portion of the membrane element such that the membrane element is immobilized axially between the seat and the pin.

Thanks to the valve of the invention, the number of parts can be limited to three parts, which allows to reduce manufacturing and assembly costs.

A valve according to the invention may comprise one or more of the following features.

In a preferred embodiment of the invention, the casing comprises an inlet connector and an outlet connector configured to fit into each other by delimiting the internal volume of the casing, the inlet connector comprises the seat and the outlet connector comprises the pin.

In a preferred embodiment of the invention, the seat is integrated into the inlet connector and the pin is integrated into the outlet connector, for example each being made integrally by molding a plastic material.

In a preferred embodiment of the invention, the proximal portion of the membrane element is of hollow cross section to form a recess shaped to axially receive the pin giving a profile with a generally V-shaped longitudinal section.

In a preferred embodiment of the invention, the distal portion of the membrane element is of solid cross section, for example the distal portion with an end tip with a generally conical shape.

In a preferred embodiment of the invention, the membrane element has a general bell shape which flares from the distal portion to the proximal portion.

In a preferred embodiment of the invention, the pin comprises a base made integrally with an internal wall of the internal volume of the casing, the base having a star-shaped configuration, in particular with a plurality of arms of mainly radial extension at equal spacing to allow fluid flow around the base of the pin.

In a preferred embodiment of the invention, the seat comprises a circumferential axial bearing surface and the distal portion comprises an external peripheral shoulder which rests axially against the bearing surface.

In a preferred embodiment of the invention, the seat comprises a plurality of axial ribs, projecting radially from an axial wall of the internal volume, each provided with a proximal end edge which together form a discontinuous circumferential bearing surface for the distal portion of the membrane element.

In a preferred embodiment of the invention, the distribution of the ribs is regular in the circumferential direction.

In a preferred embodiment of the invention, each female or male connector is made of a plastic material, for example by injection molding of the plastic material.

The invention also relates to a spraying device for distributing washing water onto a glass surface of a motor vehicle comprising a check valve characterized in that the valve is according to the invention.

### BRIEF DESCRIPTION OF THE DRAWINGS

Other features and advantages of the invention will appear in light of the description which follows, made with reference to the appended drawings wherein:

FIG. 1 shows a perspective view of a valve according to the invention in an assembled configuration;

FIG. 2 shows an exploded perspective view of the valve of FIG. 1;

FIG. 3 shows a perspective and longitudinal sectional view of the valve of FIG. 1;

FIG. 4A and FIG. 4B show a longitudinal sectional view of the valve in a sealing configuration FIG. 4A and in a fluid opening configuration FIG. 4B;

FIG. 5A and FIG. 5B show a perspective view of a distal end of a male connector FIG. 5A and a distal end of a female connector FIG. 5B.

### DESCRIPTION OF EMBODIMENTS

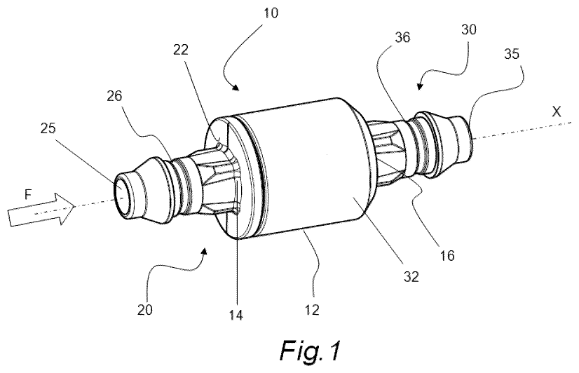

FIGS. 1 to 5 show a check valve designated as a whole by the general reference 10 and hereinafter called more simply “valve”. This valve 10 is intended to be mounted in a fluid circuit of a device, for example a device for spraying a washing liquid onto a glass surface of a motor vehicle.

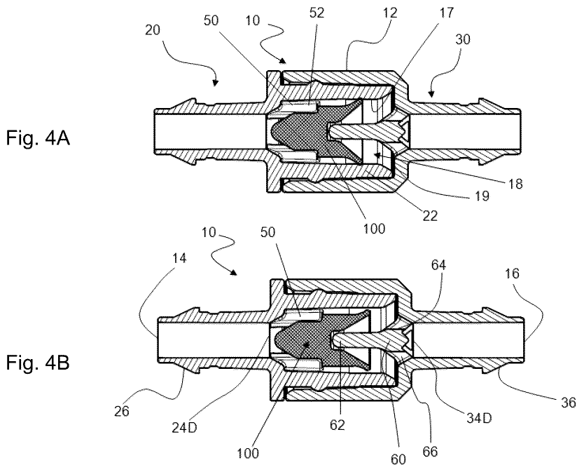

This valve 10 comprises a casing 12 delimiting an internal volume 18 (FIG. 4) provided with an inlet 14 and an outlet 16 and defining a main axis X of flow between the inlet 14 and the outlet 16 of a fluid through the casing 12.

In the remainder of the description, the direction of flow of the fluid between the inlet 14 and the outlet 16 will be designated by “passing direction” (shown schematically by the arrow F in FIG. 1) and, the opposite direction of flow will be designated by “blocked direction”.

Preferably, the casing 12 comprises a body composed of first 20 and second 30 portions assembled together, along the axis X, hereinafter designated by inlet connector 20 and outlet connector 30.

In this example, the connectors 20 and 30 are configured to fit into each other. As illustrated in the figures, the inlet connector 20 forms the male connector and the outlet connector 30 forms the female connector. The connectors 20 and 30 have complementary inter-engaging shapes delimiting, in the fitted state, the internal volume 18 of the casing 12 (FIG. 4).

In the remainder of the description, the terms “axial”, “longitudinal” and “radial” are used with reference to the main axis X. Furthermore, in the remainder of the description, the terms “proximal” and “distal” are used respectively to designate the elements of the male connector located on the side of the female connector and on the side opposite the female connector. This designation is also used similarly for the elements of the female connector with reference to their position relative to the male connector. Thus, within the meaning of the present description, an element will be qualified as proximal or distal depending on whether it is respectively close or distant axially from a coupling zone of the male 20 and female 30 connectors.

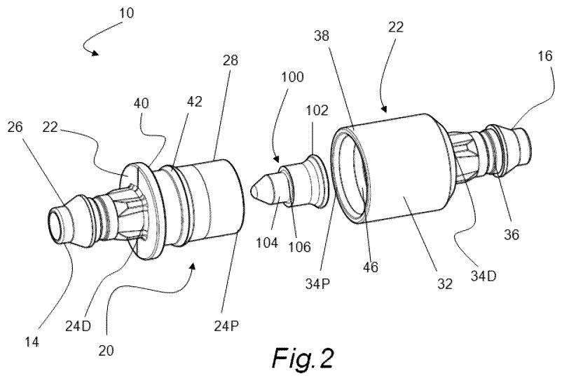

As shown in FIG. 2, the male connector 20 comprises a male casing body 22 which defines an internal passage which extends along the axis X and passes through the male body 22 from side to side. Preferably, the male casing body 22 is here extended from the inlet 14 of the casing 12 by an inlet tip 24 opening onto an inlet 25 of the valve 10. As visible in FIG. 2, the male casing body 22 comprises a proximal end 24P for coupling with the female connector 30 and a distal end 24D for connection to a fluid conduit (conduit not shown in the figures) via the inlet tip. For example, the inlet tip 24 is configured to be fitted into a flexible pipe. Furthermore, the two proximal 24P and distal 24D ends are connected together by a peripheral wall 28 externally delimiting the male casing body 22.

Similarly, as shown in FIG. 2, the female connector 30 includes a female casing body 32 which defines an internal passage which extends along the axis X and passes through the female body 30 from side to side. Preferably, the female casing body 32 is here extended from the inlet 16 of the casing 12 by an outlet tip 34 opening onto the outlet 35 of the valve 10.

In the example described, the inlet 24 and outlet 34 tips extend longitudinally along the main axis. Of course, in a non-illustrated variant of the invention, the inlet 24 and outlet 34 tips may comprise an elbow shape or a T or Y shape without departing from the scope of the invention.

The female casing body 30 comprises a proximal end 36P for coupling with the male connector 12 and a distal end 36D for connection to a fluid conduit of a fluid transfer circuit (circuit not shown in the figures) via the outlet tip. The two ends 34P and 34D are connected together by a peripheral wall 38 externally delimiting the female casing body 32.

In the preferred embodiment of the invention, the female casing body 32 is in the general shape of a socket and the male casing body 22 is in the general shape of a plug configured to plug in, up to a final coupling position, inside the female casing body 32.

For this purpose, as illustrated in FIG. 2, the male casing body 22 is provided, on its peripheral wall 28, with an annular external axial abutment flange 40 against which the proximal coupling end 34P of the female connector 30 abuts in the axial direction X during their mutual fitting.

Furthermore, preferably, the male casing body 22 is provided on the peripheral wall 38 with an annular latching bead 42 capable of cooperating with a complementary internal groove 44 formed inside the female casing body 32.

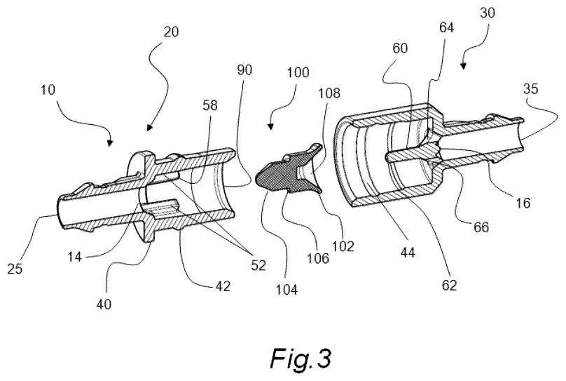

These connectors 20 and 30 are shown in an uncoupled configuration in FIGS. 2 and 3 wherein the male connector 20 and the female connector 30 are spaced apart from each other and in a coupled configuration in FIGS. 1 and 4 wherein the male connector 20 and the female connector 30 are plugged into each other.

In accordance with the invention, the valve 10 also comprises a membrane element 100 which is designed to extend, axially, at least partially inside the internal volume 18 of the casing 12.

In particular, the membrane element 100 comprises a body or envelope of longitudinal shape divided in a longitudinal direction into at least two functional portions, a proximal portion 102 for contact with the internal wall of the volume 18 and a distal portion 104 for guiding and centering the element 100 inside the volume 18 of the casing 12.

The body of the membrane element 100 has a decreasing cross section between the proximal portion 102 and the distal portion 104. The body of the element 100 has for example a general bell shape. The proximal portion 102 is elastically deformable and configured to sealingly contact the axial internal wall 17 of the volume 18 of the casing.

According to the invention, the contact portion 102 is radially elastically deformable between a sealing rest position by contact against a contact region of the axial wall 17 of the volume 18 of the casing 12 and a deformed fluid opening position wherein the fluid can flow around and along the membrane element 100, in the passing direction F between the inlet 14 and the outlet 16.

Preferably, as illustrated in the figures, the membrane element 100 is provided in its distal portion 104 with a head, of generally conical shape, and is extended in its proximal portion 102 by a frustoconical annular skirt which flares towards the outlet 16.

Preferably, the distal portion 104 is of solid cross section and is extended by the proximal portion 102 of hollow cross section giving a profile with a longitudinal section in the general shape of a V in the proximal portion 102.

In the rest position, the contact portion 102 naturally circumferentially contacts the internal peripheral axial wall 17 of the internal volume 18 of the casing 12, in said contact region, in order to create a sealed contact of the membrane element 100 with the internal peripheral wall 17. For example, the contact of the membrane 100 and the wall 17 is made by force.

In the passing direction F, the membrane element 100 adopts the fluid opening position: the pressure of the fluid on the contact portion 102 in the passing direction deforms the contact portion 102 which folds radially towards the inside such that the contact portion 102 is detached from the peripheral wall 17 allowing the fluid to flow, around the membrane element 100.

On the contrary, in the blocked direction, that is to say in the direction of flow from the outlet 16 towards the inlet 14, the pressure of the fluid on the membrane element 100 further presses the contact portion 102 against the peripheral wall 17 so that any backflow of fluid in the direction opposite to the passing direction F is prevented. In the illustrated example of the invention, the hollowed-out contact portion 102 is filled with fluid, further pressing the sealing skirt against the wall 17.

In order to position and maintain the membrane element 100 inside the valve 10, according to the invention, the casing 12 comprises on the side of the inlet 14 an internal seat 50 for receiving the distal end portion 104 and on the outlet 16 side a central axial extension pin 60 configured to extend inside the proximal end portion 102 of the membrane element 100 such that the membrane element 100 is maintained, immobilized axially, centrally against the seat 50 by the central pin 60.

Advantageously, as illustrated in the figure, the contact portion 102 of the membrane element 100 is of hollow cross section to form a recess 108 shaped to axially receive the pin 60. The pin 60 is in the shape of a finger provided at its top with a free proximal end portion 62 and at its base with a distal end portion 64 attached to a region of the internal wall of the volume 18 of the casing 12.

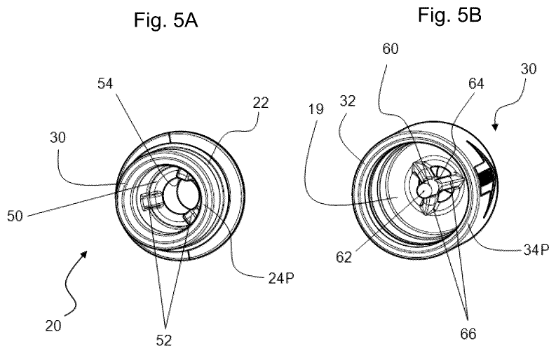

As is visible in FIG. 5B, the base 64 of the finger 60 is preferably made integrally with a transverse wall 19 of the volume 18 which extends transversely and inside which the outlet tip 34 opens.

For example, the base 64 has a star-shaped configuration, with a plurality of arms 66 of mainly radial extension at equal spacing to allow fluid flow around the base 64 of the finger 60.

In the example illustrated in the figures and in a non-limiting manner, the inlet connector 20 carries the receiving seat 50 and the outlet connector 30 carries the central pin 60.

As illustrated in FIG. 5A, the annular receiving seat 50 is here integrated into the body 22 of the male connector 20. In the example described, the annular seat 50 comprises a plurality of axial extension ribs 52 and projecting radially from a face of the internal peripheral wall 17 of the volume 18 of the casing 12. These axial ribs 52 delimit therebetween an annular housing 54 inside which is housed the distal portion 104 of the membrane 100. These ribs 52 allow longitudinally guiding and centering the membrane 100 inside the casing 12 body. These ribs 52 formed in relief on the internal face of the peripheral wall 17 of the internal volume 18 of the casing 12 form spacers which allow to maintain a radial distance between the internal wall 17 and the external envelope of the guide portion 104 of the membrane 100.

Preferably, the ribs 52 are made integrally with the internal wall 17 of the volume 18 of the casing 12, here the internal wall of the casing body of the male connector 20.

In the example described, there are three ribs 52. However, it is understood that the number, shape or arrangement of the ribs 52 is in no way limiting. Preferably, the distribution of the ribs 52 is regular in the circumferential direction.

Preferably, the membrane 100 comprises in its distal portion 104 an external annular peripheral shoulder 106 giving the envelope of the distal portion 104 a stepped external profile.

When mounting the membrane 100 inside the housing 54 delimited radially by the ribs 52, the shoulder 106 of the membrane 100 abuts axially against the end edges of the ribs 52.

In this example, the diameter of the cross section of the distal portion 104 of the membrane 100 is chosen less than the diameter of the cross section of the internal volume 18 but greater than the section of the housing 54 delimited by the ribs 52.

Thus, the membrane 100 axially abuts against the ribs 52 by its step 106 which rests axially against the distal end edges 58 of the ribs 52. The edges 58 together form a discontinuous circumferential support surface which allows the fluid to flow around the membrane 100 at the guide portion 104.

Preferably, each female 30 or male 20 connector is made of a plastic material, for example by injection molding of the plastic material.

The main operating aspects of a valve according to the invention will now be described with reference to FIGS. 1 to 5.

In the rest position of the membrane element 100 of the valve 10, as illustrated in FIG. 4A, a fluid pressure present on the side of the outlet tip 34 (or a depression prevailing on the side of the inlet tip 24) applies the membrane element 100 against the contact region of the internal wall 17 of the volume 18, so that the proximal portion 102 of the membrane element 100 closes the passage orifice of the casing 12, thus preventing any backflow of the fluid.

In the open position of the membrane element 100, as illustrated in FIG. 4B, the membrane 100 is radially “detached” from the contact region of the wall 17 and allows the circulation of the fluid, in a direction called “passing” direction (arrow F) from the inlet tip 24 to the outlet tip 34 passing through the periphery of the membrane element 100.

When the washing liquid flows from the inlet 14 towards the outlet 16 in the passing direction F, the liquid forces the opening of the seal formed in the contact region between the membrane element 100 and the casing 12 thus allowing for the liquid to flow towards the outlet 16. Thus, when the liquid flows from the inlet to the outlet, the liquid separates the contact portion 102 of the membrane element 100 from the contact region of the casing 12 and the liquid may flow.

When, on the other hand, the liquid attempts to flow from the outlet 16 to the inlet 14, it flows into the recess of the membrane element 100, which forces the contact portion 102 of the membrane element 100 in stronger contact with the contact region of the casing 12, thereby preventing the flow of liquid between the contact portion 102 of the membrane element 100 and the contact region of the casing 12 and thereby preventing the liquid from flowing from the outlet 16 of membrane 100 to the inlet 14.

Of course, the invention is not limited to the embodiments previously described. Other embodiments within the reach of the person skilled in the art can also be considered without departing from the scope of the invention defined by the claims below.

1. A check valve for a fluid circuit of a motor vehicle, comprising a casing delimiting an internal volume provided with an inlet, an outlet and defining a main axis X of flow of fluid between the inlet and the outlet through the casing, a membrane element, extending at least partially inside the internal volume of the casing, the membrane element having a contact portion radially elastically deformable between a sealing position wherein the contact portion contacts an internal wall of the internal volume and a fluid opening position wherein the fluid can flow from the inlet to the outlet around the membrane element, wherein the membrane element axially has a decreasing cross section between a proximal end portion forming the contact portion and an opposite distal end portion, the casing comprises on the inlet side an internal seat for receiving the distal portion and on the outlet side an axial extension pin configured to extend inside the proximal portion of the membrane element such that the membrane element is immobilized axially between the seat and the pin.

2. The valve according to claim 1, wherein the casing comprises an inlet connector and an outlet connector configured to fit into each other by delimiting the internal volume of the casing, the inlet connector comprises the seat and the outlet connector comprises the pin.

3. The valve according to claim 2, wherein the seat is integrated into the inlet connector and the pin is integrated into the outlet connector, for example each being made integrally by molding a plastic material.

4. The valve according to claim 1, wherein the proximal portion of the membrane element is of hollow cross section to form a recess shaped to axially receive the pin giving a profile with a generally V-shaped longitudinal section.

5. The valve according to claim 1, wherein the distal portion of the membrane element is of solid cross section, for example the distal portion with an end tip with a generally conical shape.

6. The valve according to claim 1, wherein the membrane element has a general bell shape which flares from the distal portion to the proximal portion.

7. The valve according to claim 1, wherein the pin comprises a base made integrally with an internal wall of the internal volume of the casing, the base having a star-shaped configuration.

8. The valve according to claim 1, wherein the seat comprises a circumferential axial bearing surface and the distal portion comprises an external peripheral shoulder which rests axially against the bearing surface.

9. The valve according to claim 8, wherein the seat comprises a plurality of axial ribs, projecting radially from an axial wall of the internal volume, each provided with a proximal end edge which together form a discontinuous circumferential bearing surface for the distal portion of the membrane element.

10. The valve according to claim 9, wherein the distribution of the ribs is regular in the circumferential direction.

11. The valve according to claim 1, wherein each female or male connector is made of a plastic material, for example by injection molding of the plastic material.

12. A spraying device for distributing washing water onto a glass surface of a motor vehicle comprising a check valve wherein the valve is according to claim 1.
